(19) United States
(12) Patent Application Publication
(10) Pub. No.: US 2009/0180126 A1
(43) Pub. Date: Jul. 16, 2009

(54) Information processing apparatus, method of generating document, and computer-readable recording medium

(75) Inventor: Fabrice Matulic, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/318,684

(22) Filed: Jan. 6, 2009

(30) Foreign Application Priority Data
Jan. 11, 2008 (JP) 2008-004800

(51) Int. Cl. G06F 3/12; G06F 3/14

(52) U.S. Cl. 358/1.1; 715/243

(57) ABSTRACT

In an information processing apparatus, when input of content information is received, a content extracting unit extracts a plurality of contents each including the content information from among the contents contained in the document stored in a storage unit. Then, a relation calculating unit calculates a degree of semantic relatedness between the extracted contents, and a layout generating unit determines positions of the extracted contents on a new document based on the degree of the semantic relatedness and arranges the extracted contents on the positions thereby generating the new document.

### CROSS-REFERENCE TO RELATED APPLICATIONS

The present application claims priority to and incorporates by reference the entire contents of Japanese priority document 2008-004800 filed in Japan on Jan. 11, 2008.

### BACKGROUND OF THE INVENTION

1. Field of the Invention

The present invention relates to a technology for generating a document from a plurality of contents.

2. Description of the Related Art

In a conventional technology, when a user creates a document or a document file for printing as a magazine or a newspaper, the user collects contents such as articles and images, judges the degree of importance or a visual quality of each of the contents, and decides a layout of the contents of the document. This document is then printed out as the magazine or the newspaper.

For example, United States Patent No. 7243303 discloses a technology in which positions and sizes of contents included in a document are determined based on a predetermined relational expression depending on the degree of importance of each of the contents that is determined by a user in advance, the contents are then automatically arranged on the document based on the determined positions and sizes, and the document is output as data or printed out.

However, according to the above technology, because the user determines the degree of importance of each of target contents to be edited and relatedness between the contents, when there are a large amount of contents, the user needs to determine the degree of importance of all of the contents, which causes inconvenience to the user.

Furthermore, because the degree of importance of the contents is determined by the user, when the same contents are arranged on a document by different users having different criteria for determination of the degree of importance and the relatedness of the contents, the layout disadvantageously changes.

### SUMMARY OF THE INVENTION

It is an object of the present invention to at least partially solve the problems in the conventional technology.

According to an aspect of the present invention, there is provided an information processing apparatus including a storage unit that stores therein a document containing a plurality of contents; an input receiving unit that receives content information; a content extracting unit that extracts a plurality of contents each including the content information from among the contents contained in the document stored in the storage unit; a relation calculating unit that calculates a degree of semantic relatedness between extracted contents extracted by the content extracting unit; and a layout generating unit that determines positions of the extracted contents on a new document based on the degree of the semantic relatedness and arranges the extracted contents on the positions thereby generating the new document.

According to another aspect of the present invention, there is provided a method of generating a document including storing a document containing a plurality of contents in a storage unit; receiving content information; extracting a plurality of contents each including the content information from among the contents contained in the document stored in the storage unit; calculating a degree of semantic relatedness between extracted contents extracted at the extracting; determining positions of the extracted contents on a new document based on the degree of the semantic relatedness; and arranging the extracted contents on the positions determined at the determining thereby generating the new document.

According to still another aspect of the present invention, there is provided a computer-readable recording medium that stores therein a computer program containing computer program codes which when executed on a computer causes the computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an information processing apparatus according to a first embodiment of the present invention;

FIG. 2 is a schematic diagram of examples of documents stored in a storage unit shown in FIG. 1;

FIG. 3 is a schematic diagram of text included in a document stored in the storage unit shown in FIG. 1;

FIG. 4 is a schematic diagram of a table included in a document stored in the storage unit shown in FIG. 1;

FIG. 5 is a schematic diagram of an image included in a document stored in the storage unit shown in FIG. 1;

FIG. 6 is a schematic diagram for explaining an example in which text is described around the image shown in FIG. 5;

FIG. 7 is a schematic diagram for explaining an example of an output setting screen displayed by a display unit shown in FIG. 1;

FIG. 8 is an example of a matrix of numeric values each indicating similarity between contents generated by a relation calculating unit shown in FIG. 1;

FIG. 9 is an example of a relation chart indicating relations between contents generated by the relation calculating unit;

FIG. 10 is a schematic diagram for explaining a layout of contents generated by a layout generating unit shown in FIG. 1;

FIG. 11 is a schematic diagram of a situation in which a plurality of contents is displayed on the display unit;

FIG. 12 is a schematic diagram for explaining of a situation in which only selected ones of the contents shown in FIG. 11 are displayed by the display unit;

FIG. 13 is a flowchart of a document generation operation performed by the information processing apparatus shown in FIG. 1;

FIG. 14 is a block diagram of an information processing system according to a second embodiment of the present invention;

FIG. 15 is a flowchart of a document generation operation performed by the information processing system shown in FIG. 14;

FIG. 16 is a block diagram of a multifunction product (MFP) according to a third embodiment of the present invention; and

FIG. 17 is a block diagram of an exemplary hardware configuration of the MFP.

### DETAILED DESCRIPTION OF THE PREFERRED EMBODIMENTS

Exemplary embodiments of the present invention are explained in detail below with reference to the accompanying drawings.

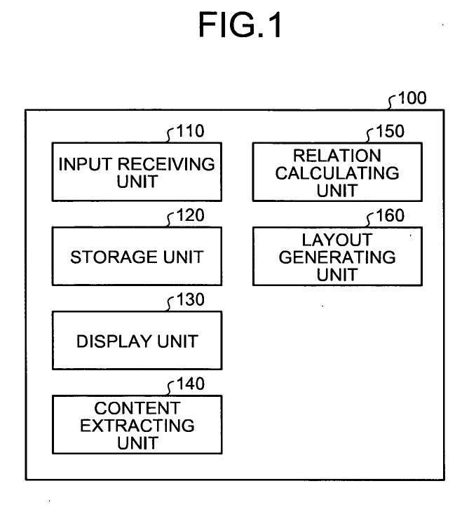

FIG. 1 is a block diagram of an information processing apparatus 100 according to a first embodiment of the present invention. The information processing apparatus 100 includes an input receiving unit 110, a storage unit 120, a display unit 130, a content extracting unit 140, a relation calculating unit 150, and a layout generating unit 160.

The input receiving unit 110 includes an input device (not shown), such as a keyboard, a mouse, or a touch panel. The input receiving unit 110 receives instructions and/or data from a user. Specifically, the input receiving unit 110 receives specification of a file or the like (hereinafter, “document”) including text document data or image data stored in the storage unit 120 and a keyword for extracting a content from a document including various texts, images, tables, or the like.

The input receiving unit 110 receives output settings that are used by the layout generating unit 160 when it arranges various contents extracted by the content extracting unit 140 on a document. Such output settings includes, for example, a format of an output file, the number of characters per page, presence or absence of column settings, and page margins.

Furthermore, the input receiving unit 110 receives specification of an area for identifying a content from a document. Specification of an area can be, for example, in the form of line numbers and page numbers, such as “from line 1 on page 2 to line 50 on page 4”.

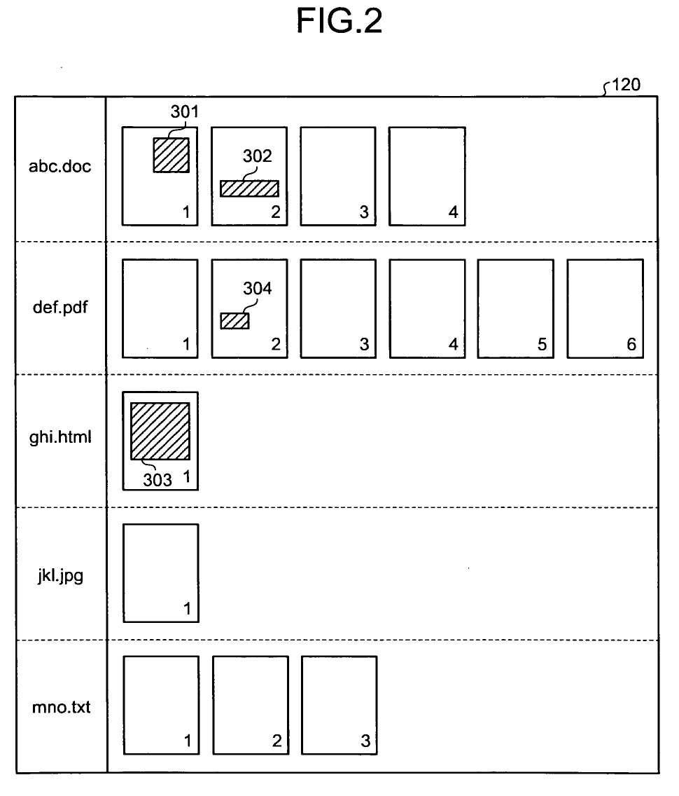

The storage unit 120 is a storage medium, such as a hard disk drive (HDD) or a memory. The storage unit 120 stores therein in advance the above documents and a document generated by the layout generating unit 160. FIG. 2 is a schematic diagram of examples of documents stored in the storage unit 120. The storage unit 120 stores therein various types of documents, such as documents abc.doc, def.pdf, ghi.html, jkl.jpg, and mno.txt. The storage unit 120 stores therein page information indicative of the number of pages included in each of the documents and content information indicative of a content included in each of the pages in an associated manner.

For example, the document abc.doc includes four pages, and the first page of the document abc.doc includes a content 301 indicated by diagonal lines shown in FIG. 2. The content 301 includes a keyword (for example, “company A”) received by the input receiving unit 110.

The second page of the document abc.doc includes a content 302 including a different keyword (for example, “management principals”) received by the input receiving unit 110 in the same manner as the first page.

Similarly, the document def.pdf includes a content 304 including a keyword (for example, “company A”) on the second page. The document ghi.html also includes a content 303 including a keyword (for example, “company A”).

The documents stored in the storage unit 120 are not limited to the types of documents shown in FIG. 2. For example, the document can be extensible markup language (XML) data, data or a mail created in the Open Document Format, a multimedia object, a Flash object, or the like.

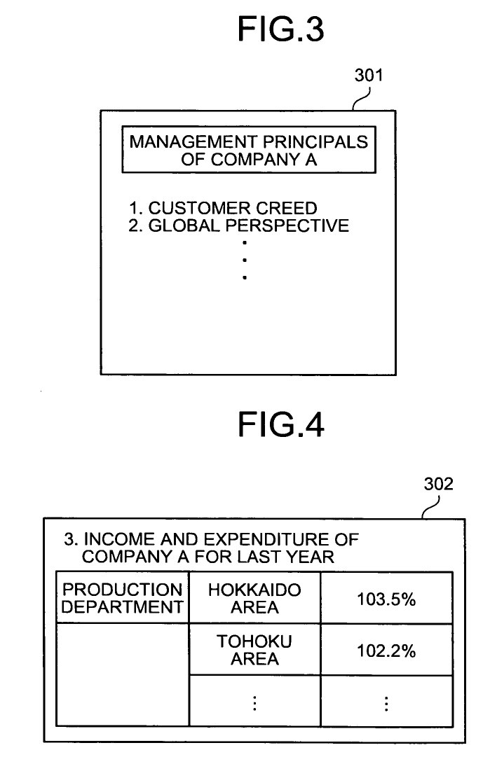

FIG. 3 is a schematic diagram of the content 301. The content 301 includes texts written in an itemized manner on the first page of the document abc.doc. When the input receiving unit 110 receives the keyword “company A” from the user, the content extracting unit 140 identifies a text including the keyword “company A” as described later. The storage unit 120 stores therein a document including a content with the keyword like the content 301.

FIG. 4 is a schematic diagram of the content 302. The content 302 includes a table indicating income and expenditure of each department of the company A. The content, other than a text, included in the document can be presented in tabular form.

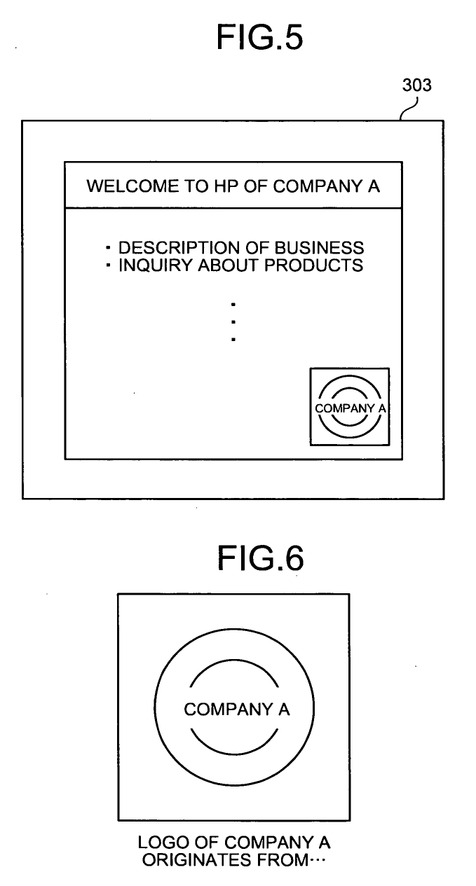

FIG. 5 is a schematic diagram of the content 303. The content 303 includes a homepage containing a logo of the company A. The logo is in the form of an image.

FIG. 6 is a schematic diagram for explaining an example in which a text for explaining the logo of the company A is described around the logo (under the logo in FIG. 6). Other content included in the document can include an image or a table and text data arranged around the image or the table for its explanation.

Furthermore, together with various data such as a text, a table, and an image, the document can include metadata that describes information (hereinafter, “attribute information”) such as date and time of creation of the data, a creator of the data, a data format, a title, and annotation. If the document includes metadata, the content extracting unit 140 determines whether the keyword received by the input receiving unit 110 matches the attribute information (for example, a creator) thereby identifying a content from a document.

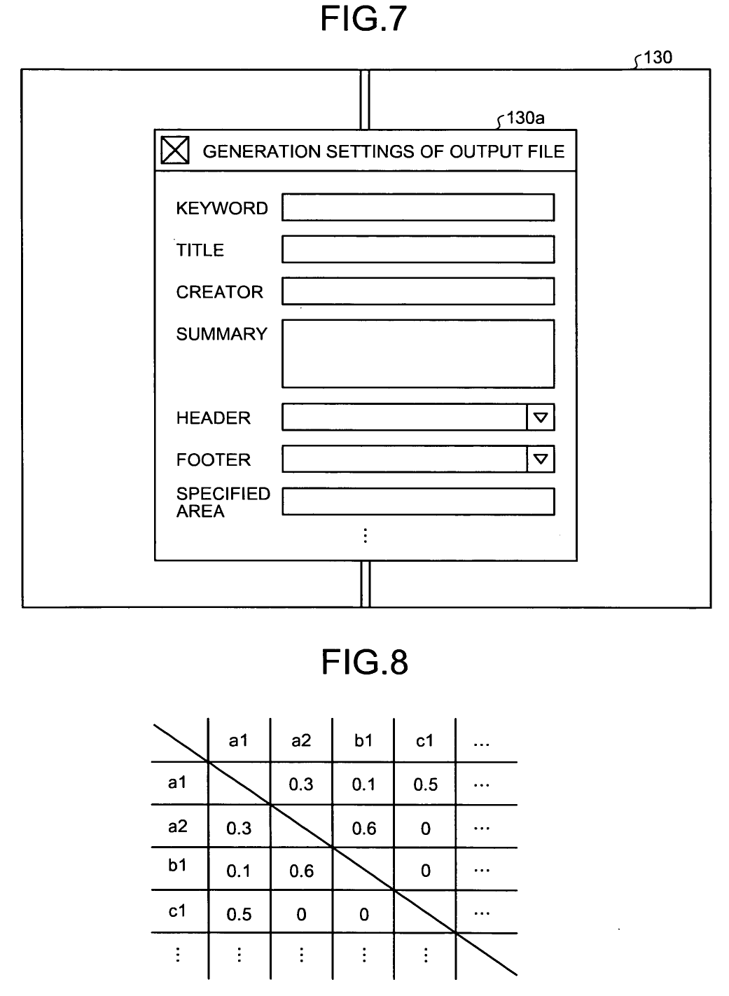

FIG. 7 is a schematic diagram for explaining an example of an output setting screen for generating a document displayed by the display unit 130. The display unit 130 includes a display device (not shown) such as a liquid crystal display (LCD). The display unit 130 displays an entry screen 130a to receive inputs, such as a keyword for extracting a content from a document, a title of a document to be generated, a creator of the document, summary information of the document, presence or absence of a header and a footer, a page format such as presence or absence of a two-column format, and a paper size if the document is to be printed out.

The display unit 130 displays contents of a document generated by the layout generating unit 160 as described later. Furthermore, if a plurality of documents is generated in accordance with various conditions received by the input receiving unit 110, the display unit 130 displays a selection screen (not shown) for a user to select one of the generated documents.

The content extracting unit 140 identifies a document including a keyword received by the input receiving unit 110 from various documents stored in the storage unit 120. The content extracting unit 140 then identifies a text or the like including the keyword as a content from the identified document, extracts the identified content from the document, and stores the extracted content in the storage unit 120.

Specifically, when the input receiving unit 110 receives a keyword, the content extracting unit 140 identifies a document including the same text as the keyword from a plurality of documents, identifies a text or the like including the same text as the keyword from the identified document, and extracts the identified text or the like as a content.

An area of the text to be extracted as the content is identified such that, for example, it is determined whether there is a blank line or a paragraph break before and after the text including the same text as the keyword, and if there is a blank line or a paragraph break before the same text as the keyword, a position of the blank line or the paragraph break is determined to be a start position of the content to be extracted.

In the same manner, if there is a blank line or a paragraph break after the same text as the keyword, a position of the blank line or the paragraph break is determined to be an end position of the content to be extracted. Thus, the start position and the end position are determined, and a text or the like in an area enclosed by the start position and the end position is extracted as a content.

For example, when extracting the content 301 shown in FIG. 3 from a document by using “company A” as a keyword, the content extracting unit 140 identifies a position at which “company A” appears (a line in which “management principals of company A” is described). The content extracting unit 140 then determines whether the previous line of the line at the identified position is a blank line, and if it is a blank line, the line is stored in a random access memory (RAM) (not shown) as a start position (start line) for identifying a content. Specifically, a position of a first blank line located before the line in which “management principals of company A” appears is stored in the RAM.

In the same manner, a position of a first blank line located after the line in which “management principals of company A” appears is stored in the RAM. A text (first and subsequent items in “management principals of company A” written in an itemized manner in FIG. 3) within an area enclosed by these blank lines is identified as a content, and the identified content is extracted from the document abc.doc.

If an image is included in the area enclosed by the start position and the end position of the content, the content extracting unit 140 recognizes both the image and a text described around the image as a content, and extracts the image and the text from the document.

For example, upon identifying the content including the keyword, the content extracting unit 140 determines whether an image is present in an area of the content by reading a tag used for embedding the image on a document or the like. The content extracting unit 140 then recognizes an area enclosed by the tag as an image, and extracts the image from the document together with a text like the text shown in FIG. 6 for explaining the image.

It is possible that after reading a text of “company A” included in the logo in the content 303 shown in FIG. 5, the content extracting unit 140 identifies an area enclosed by the tag or the like as an image, and if a descriptive text including the same text as the keyword “company A” is arranged around the image (under the image in FIG. 6), the content extracting unit 140 extracts the identified image together with the descriptive text.

It is explained above that the content extracting unit 140 identifies the content included in the document by identifying the position of a blank line, a paragraph break, or a tag, and extracts the identified content from the document. Alternatively, for example, it is possible to configure the content extracting unit 140 so as to identify the content by identifying a position of a line break, or the like.

Moreover, it is explained above that the content extracting unit 140 identifies the content by the position (the line or the tag) or the like of the text or the image included in the document, and extracts the identified content from the document. Alternatively, if a content of the document is included in a certain layout frame (specifically, a layout frame having a predetermined length and width) in advance like a newspaper article, it is possible to configure the content extracting unit 140 so as to identify a layout frame as a content, and extracts the identified content from the document. Specifically, the content extracting unit 140 can be configured to as to identify the whole text or image included in the layout frame as a content without identifying the start position and the end position of the content, the position of the tag, or the like, and extract the identified content from the document.

If the input receiving unit 110 receives specification of a keyword and an area of a content included in a document, the content extracting unit 140 can be configured to as to extract a content including the keyword received by the input receiving unit 110 within the specified area (for example, an area from line 1 on page 2 to line 50 on page 4).

The relation calculating unit 150 analyzes a semantic content of each of contents extracted from the document by the content extracting unit 140 and stored in the storage unit 120, determines how much the contents are similar to each other, and expresses similarity in numeric values.

Specifically, the relation calculating unit 150 reads a text described in a content extracted from the document by the content extracting unit 140 and stored in the storage unit 120, and determines how much the text matches a text described in a different content extracted from the document by comparing the texts using a method such as a full text searching.

If the texts match completely, the content extracting unit 140 stores “1.0” in the storage unit 120 as a numeric value indicating a degree of similarity between the contents. If the texts do not match at all, the content extracting unit 140 stores “0.0” in the storage unit 120 as a numeric value indicating a degree of similarity between the contents.

Furthermore, if only parts of the texts match, one approach for the relation calculating unit 150 is to determine the degree of the similarity between the contents based on the number of hits of the keyword included in each of the contents, and stores a numeric value, such as “0.3” or “0.6”, as a determination result in the storage unit 120. If a plurality of keywords is received, it is possible that the relation calculating unit 150 assigns a weight to each of a first keyword and a second keyword, and calculates a numeric value indicating the degree of the similarity between contents by comparing the numbers of hits of the first and the second keywords in the contents. In such a case, the relation calculating unit 150 calculates a numeric value indicating the degree of the similarity between the contents with respect to each of the keywords, and stores the calculated numeric value in the storage unit 120.

FIG. 8 is an example of a matrix of numeric values each indicating the similarity between contents generated by the relation calculating unit 150. Upon calculating the degree of the similarity between contents as the numeric value, the relation calculating unit 150 generates a matrix obtained by presenting the numeric values each indicating the degree of the similarity between contents in tabular form. The relation calculating unit 150 can generate such a matrix for each keyword.

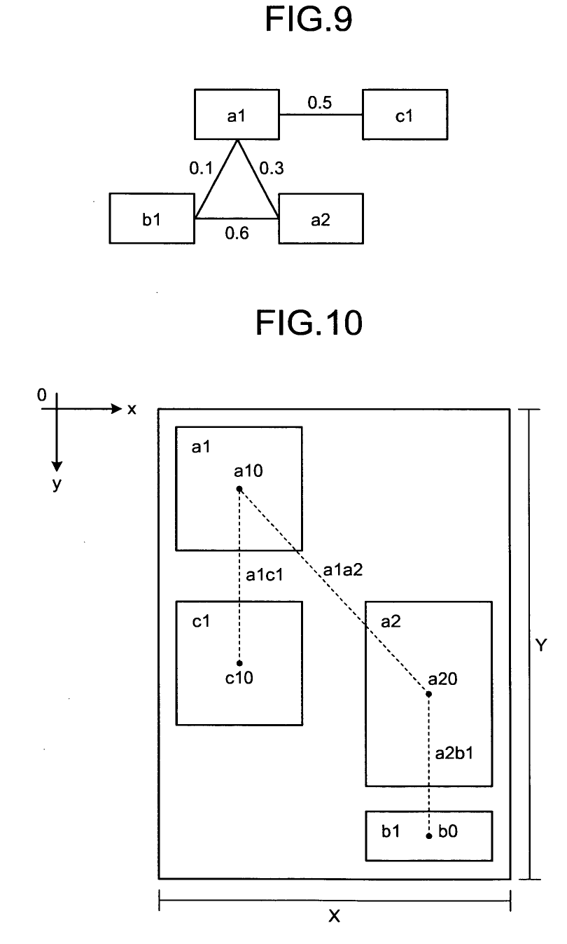

FIG. 9 is an example of a relation chart indicating relations between contents generated by the relation calculating unit 150. The relation calculating unit 150 generates the relation chart by referring to the generated matrix. For example, the relation calculating unit 150 calculates a numeric value indicating a degree of the similarity between a content a1 and a content a2 shown in FIG. 8 as “0.3” based on the number of hits of a keyword included in each of the content a1 and the content a2, and then generates a relation chart obtained by connecting the content a1 and the content a2 by a line as shown in FIG. 9. In the same manner, the relation calculating unit 150 generates a relation chart by connecting the content a1 and a content b1, the content a1 and a content c1, and the content a2 and the content b1.

The layout generating unit 160 arranges each content on a page of a new document based on the relation chart shown in FIG. 9 and the numeric values in the matrix shown in FIG. 8.

FIG. 10 is a schematic diagram for explaining a layout of the contents a1, a2, b1, and c1 generated by the layout generating unit 160 based on the numeric values indicating the degrees of the similarities between the contents a1, a2, b1, and c1. Specifically, the layout generating unit 160 determines a position of a content as a reference (for example, the center point a10 of the content a1) on a page of a new document that has a preset length Y and width X in which an upper left end of the page is defined as zero, and a right direction and a downward direction in FIG. 10 are defined as an x axis and a y axis, respectively.

The layout generating unit 160 arranges a content (for example, the content c1) having a high degree of the similarity to the content a1 at a position (for example, c10) located apart from the center point a10 by a distance (a1c1) corresponding to the numeric value “0.5” indicating the similarity between the contents a1 and c1. If the numeric value indicating the similarity between the contents is “1.0”, the layout generating unit 160 determines that the contents match completely, and arranges the content adjacent to the content as a reference on a new document.

If the contents do not match at all, the numeric value indicating the similarity between the contents is “0.0”, and therefore the layout generating unit 160 arranges the contents at positions farthest away from each other with the length y and the width x as maximum values. For example, one content is arranged on an upper end of a page of a document, and the other content is arranged on a lower end of the page.

Specifically, when the numeric value indicating the degree of the similarity between the contents is other than “1.0” and “0.0” (for example, “0.5”), the layout generating unit 160 proportionally divides the distances corresponding to the numeric values “1.0” and “0.0” to calculate a distance from the content as a reference (for example, the content a1), and arranges the content on a new document based on the calculated distance.

If the input receiving unit 110 receives output setting information (for example, a format of an output file, the number of characters per page, presence or absence of column settings, page margins) with respect to the document, the layout generating unit 160 arranges each content on a new document based on the output setting information and the numeric value indicating the degree of the similarity between the contents calculated by the relation calculating unit 150.

For example, if a file format is a document file format (for example, AA.doc) and the output settings such as no page margins and a two-column format are specified, the contents are arranged on the layout shown in FIG. 10.

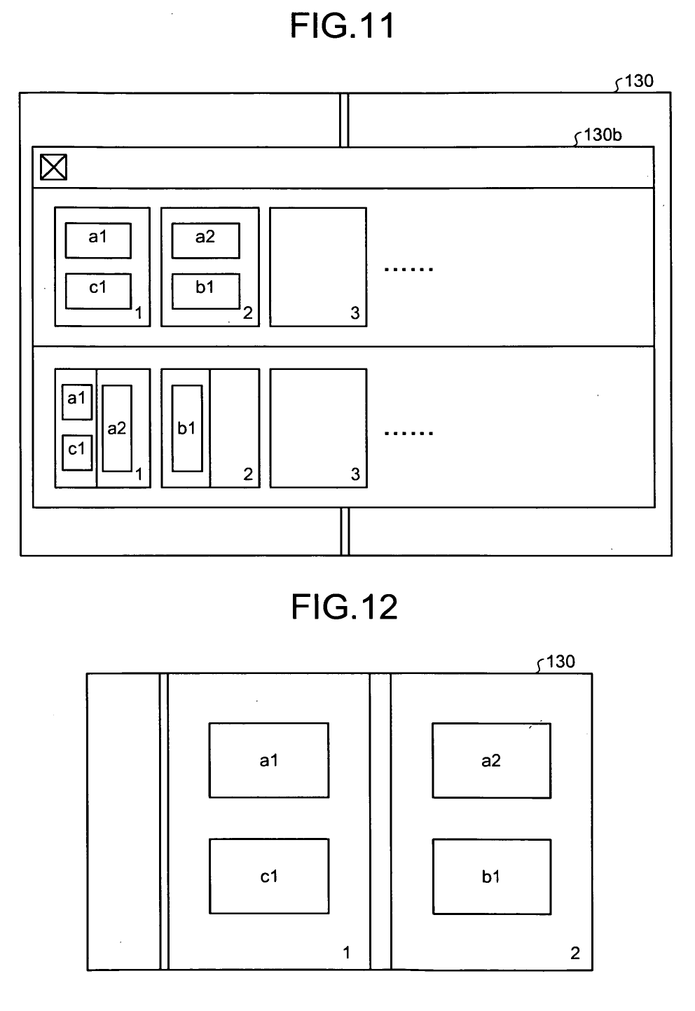

When the layout generating unit 160 arranges each of the contents on the document, the display unit 130 displays the contents. FIG. 11 is a schematic diagram for explaining an example of display of the generated document displayed on a window 130b of the display unit 130 when the output settings are specified such that the document is displayed on layouts with the two-column format and without the two-column format.

FIG. 12 is a schematic diagram for explaining a case where the input receiving unit 110 receives specification from a user such that the document displayed by the display unit 130 shown in FIG. 11 is to be output by the output settings without the two-column format. In this manner, contents are extracted from documents stored in the storage unit 120, and a new document is generated by combining the extracted contents.

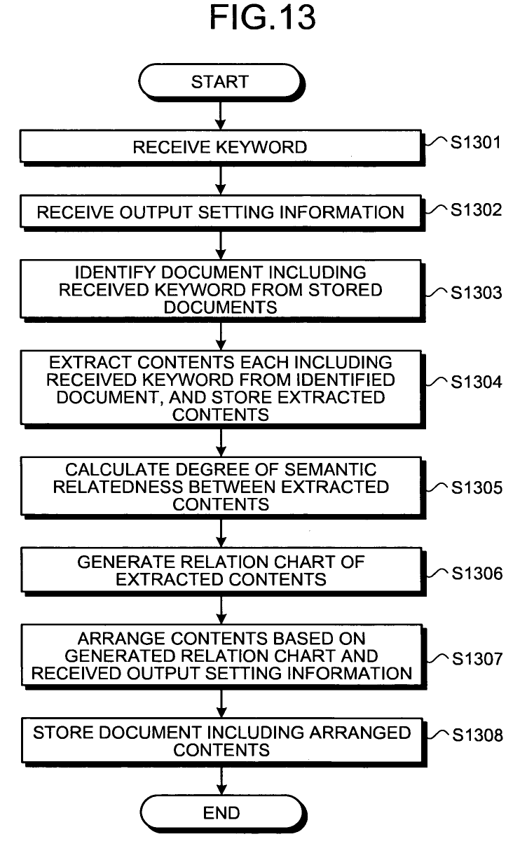

FIG. 13 is a flowchart of a document generation operation performed by the information processing apparatus 100. In the following description, it is assumed that the storage unit 120 stores therein the documents shown in FIG. 2, and the input receiving unit 110 does not receive specification of an area for identifying a content from a document.

The input receiving unit 110 receives a keyword for extracting a content from a document (Step S1301), and receives output setting information of a new document to be generated (Step S1302).

The content extracting unit 140 then extracts a document including the keyword received at Step S1301 from the documents stored in the storage unit 120 (Step S1303).

The content extracting unit 140 then reads contents described in the document extracted at Step S1303, extracts a plurality of contents each including the keyword received at Step S1301 from the document, and stores the extracted contents in the storage unit 120 (Step S1304).

The relation calculating unit 150 reads a text included in each of the contents stored in the storage unit 120 at Step S1304, determines the number of hits of the keyword received by the input receiving unit 110 in the text, and calculates a numeric value indicating the degree of the similarity (semantic relatedness) between the contents (Step S1305).

Furthermore, the relation calculating unit 150 generates a matrix of the numeric value calculated at Step S1305, and generates a relation chart by using the numeral value in the matrix (Step S1306).

The layout generating unit 160 then arranges the contents extracted by the content extracting unit 140 at Step S1304 on a new document based on the output setting information received by the input receiving unit 110 at Step S1302 and the numeric value calculated by the relation calculating unit 150 at Step S1305 (Step S1307), and then stores the new document including the above arranged contents in the storage unit 120 (Step S1308). When the operation at Step S1308 ends, all of the operations for generating the new document end.

As described above, according to the first embodiment, the storage unit 120 stores therein documents, the input receiving unit 110 receives a keyword for extracting a content from a document, and the content extracting unit 140 extracts a plurality of contents each including the keyword received by the input receiving unit 110 from a document. Furthermore, the relation calculating unit 150 calculates a degree of semantic relatedness between the contents extracted by the content extracting unit 140, and the layout generating unit 160 determines positions of the contents on a new document based on the degree of the semantic relatedness between the contents and arranges the contents on the positions thereby generating the new document. Thus, it is possible to generate a document by extracting the contents in a simple and objective manner without causing any inconvenience to users.

Moreover, a content of a document includes image data or text data, and the image data includes attribute information indicating whether the image data includes a text. The content extracting unit 140 extracts a plurality of contents from a document based on the keyword received by the input receiving unit 110 and the attribute information included in the image data or the text included in the text data. Thus, it is possible to generate a document by extracting the contents in a simpler and more objective manner.

Furthermore, the attribute information is a text arranged around the image data, and the content extracting unit 140 extracts a plurality of contents from a document based on the keyword received by the input receiving unit 110 and the attribute information arranged around the image data or the text included in the text data. Thus, it is possible to generate a document by extracting the contents in a more objective and efficient manner.

Moreover, the relation calculating unit 150 generates a relation chart indicating the similarity between contents by comparing the contents, and calculates the degree of the semantic relatedness between the contents based on the generated relation chart, so that a user can visually determine the relatedness between the contents in a process of generating the document.

Furthermore, the relation calculating unit 150 generates a table indicating the similarity between contents by comparing contents, and calculates the degree of the semantic relatedness between the contents based on the generated table, so that a user can promptly determine the relatedness between the contents in a process of generating the document.

Moreover, the input receiving unit 110 receives area information indicating a predetermined area in the document, the content extracting unit 140 extracts a plurality of contents each including the keyword received by the input receiving unit 110 from the predetermined area, and the relation calculating unit 150 calculates the degree of the semantic relatedness between the contents extracted by the content extracting unit 140. Thus, a user can determine the relatedness between the contents in a flexible manner in a process of generating the document.

Moreover, the relation calculating unit 150 converts the calculated degree of the semantic relatedness between the contents into a position relation in a coordinate system on a new document with one of the contents as a reference, and the layout generating unit 160 determines positions of the contents on the new document based on the position relation converted by the relation calculating unit 150. Thus, a user can determine the relatedness between the contents more visually and intuitively.

As described above, according to the first embodiment, a plurality of contents is extracted from a document stored in the storage unit 120, a numeric value indicating the similarity between the contents is calculated, and the contents are arranged on a new document based on the numeric value. However, a document including target contents with which a new document is to be generated can be acquired in the Internet environment or a local area network (LAN) environment. In the following description, it is explained that an information processing apparatus retrieves a document stored in a server apparatus via a network, stores the document in a storage unit of the information processing apparatus, extracts a plurality of contents from the document stored in the storage unit, and calculates the similarity between the contents, thereby generating a new document.

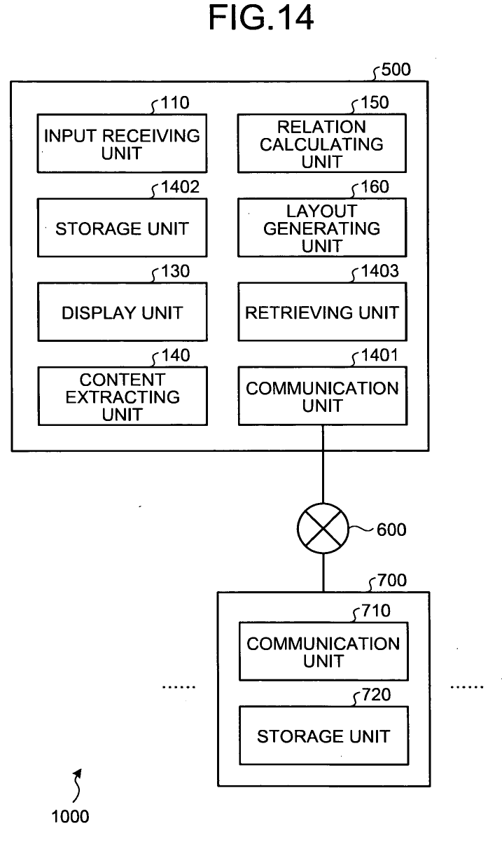

FIG. 14 is a block diagram of an information processing system 1000 according to a second embodiment of the present invention. The information processing system 1000 includes an information processing apparatus 500, a server apparatus 700, and a communication network 600. The information processing apparatus 500 is different from the information processing apparatus 100 in that the information processing apparatus 500 further includes a communication unit 1401, a storage unit 1402, and a retrieving unit 1403. In the following description, the same reference numerals are used for the same components as those in the first embodiment, and their explanations are omitted.

The communication unit 1401 is a communication interface (I/F) that mediates communication between the information processing apparatus 500 and the communication network 600. The communication unit 1401 is an intermediate unit that causes the retrieving unit 1403 to acquire a document from the server apparatus 700 and store the acquired document in the storage unit 1402.

The storage unit 1402 is a recording medium such as an HDD or a memory. The storage unit 1402 stores therein a local document stored in the information processing apparatus 500 in advance as well as a document acquired by the retrieving unit 1403 from the server apparatus 700. Because the specific configuration of the storage unit 1402 is the same as that in the first embodiment, its explanation is omitted.

The retrieving unit 1403 retrieves a document including the same text as the keyword received by the input receiving unit 110 from documents stored in the server apparatus 700, and stores the retrieved document in the storage unit 1402.

When the retrieving unit 1403 retrieves and acquires a document from the server apparatus 700, the communication network 600 transmits the document from the server apparatus 700 to the retrieving unit 1403. The communication network 600 is the Internet, or a network such as a LAN or a wireless LAN.

The server apparatus 700 includes a communication unit 710 and a storage unit 720.

The communication unit 710 is a communication I/F that mediates communication between the server apparatus 700 and the communication network 600. The communication unit 710 is an intermediate unit that receives a document retrieval request from the retrieving unit 1403, and transmits a document stored in the storage unit 720 to the information processing apparatus 500.

The storage unit 720 is a recording medium such as an HDD or a memory. The storage unit 720 stores therein documents including a text, an image, an article, or the like. Because the specific configuration of the storage unit 720 is the same as that in the first embodiment, its explanation is omitted.

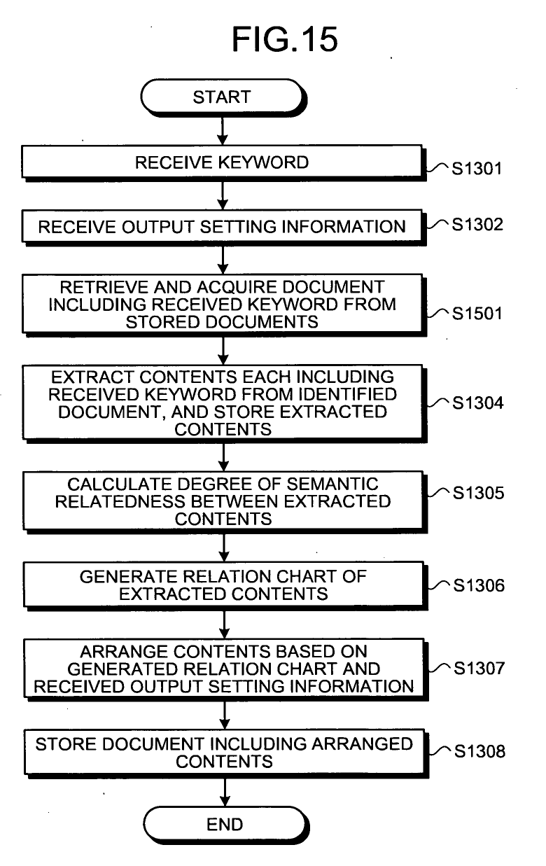

The information processing system 1000 is different from the information processing apparatus 100 only in that the retrieving unit 1403 retrieves and acquires a document from the server apparatus 700 and stores the acquired document in the storage unit 1402, and therefore only that operation is explained below with reference to FIG. 15. Because the other operations are the same as those in the first embodiment, the same reference numerals are used for the same components as those in the operations in the first embodiment and their explanations are omitted.

FIG. 15 is a flowchart of a document generation operation performed by the information processing system 1000. When the input receiving unit 110 receives a keyword (Step S1301) and receives output setting information of a new document to be generated (Step S1302), the retrieving unit 1403 accesses the server apparatus 700 via the communication unit 1401 and the communication network 600, retrieves a document including the keyword received at Step S1301, acquires the retrieved document, and stores the acquired document in the storage unit 1402 (Step S1501). The content extracting unit 140 extracts a plurality of contents each including the keyword from the document stored in the storage unit 1402. Then, the same operations as those in the first embodiment are performed (Steps S1304 to S1308).

As described above, in the information processing apparatus 500 connected to the server apparatus 700 via the communication network 600, the communication unit 1401 acquires a document from the server apparatus 700, the storage unit 1402 stores therein the document acquired by the communication unit 1401, the input receiving unit 110 receives information (keyword) for identifying a content from a document, and the content extracting unit 140 extracts a plurality of contents each including the keyword received by the input receiving unit 110 from the document. Moreover, the relation calculating unit 150 calculates the degree of the semantic relatedness between the contents extracted by the content extracting unit 140, and the layout generating unit 160 determines positions of the contents on a new document based on the degree of the semantic relatedness between the contents and arranges the contents on the positions thereby generating the new document. Thus, it is possible to generate a new document by accessing a document via the network and extracting contents from the document in a simple and objective manner without causing any inconvenience to users.

It is explained in the first and the second embodiments that the contents are identified and extracted from the document stored in the storage unit by using the keyword received by the input receiving unit 110, the numeric value indicating the similarity between the contents is calculated, and the contents are arranged on a new document based on the calculated numeric value. However, when a document is to be generated by extracting a content other than previously stored contents, such as an article included in a newspaper or a magazine, the article included in a page of the newspaper or the magazine needs to be read to generate a document. Therefore, in the following description, it is explained that a text or an image included in a page of a newspaper or a magazine is read, image data obtained by reading the text or the image is generated as a document, a plurality of contents is extracted from the generated document, and the similarity between the contents is calculated thereby generating a new document.

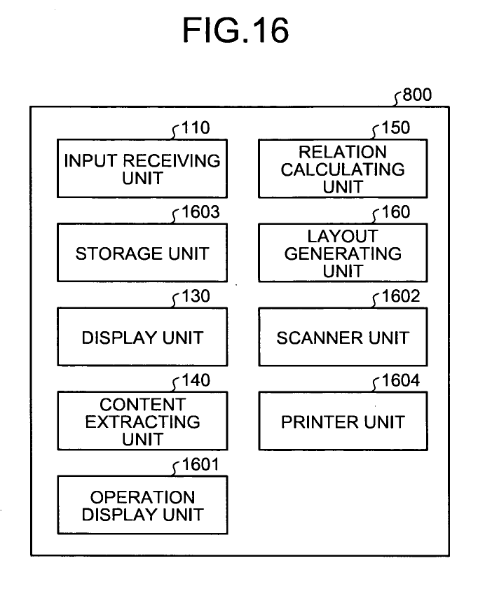

FIG. 16 is a block diagram of a multifunction product (MFP) 800 according to a third embodiment of the present invention. The MFP 800 is different from the information processing apparatus 100 in that the MFP 800 includes an operation display unit 1601, a scanner unit 1602, a storage unit 1603, and a printer unit 1604. In the following description, the same reference numerals are used for the same components as those in the first embodiment, and their explanations are omitted. Although it is explained below that the third embodiment is applied to the MFP 800 including a copy function, a facsimile (FAX) function, a print function, a scanner function, and the like in one casing, it can be applied to an apparatus that has the print function.

The operation display unit 1601 includes a display (not shown) such as a liquid crystal display (LCD). The operation display unit 1601 is an I/F to specify setting information (print setting information, such as presence or absence of duplex print, enlarged print and reduced print, and scale of enlargement or reduction) when the scanner unit 1602 reads an original of a newspaper, a magazine, or the like in accordance with an instruction from a user and stores data obtained by reading the original in the storage unit 1603 or when the printer unit 1604 outputs a document stored in the storage unit 1603.

The scanner unit 1602 includes an automatic document feeder (ADF) (not shown) and a reading unit (not shown). Upon receiving a user's instruction from the operation display unit 1601, the scanner unit 1602 reads an original placed at a predetermined position on an exposure glass in accordance with output settings for a document, and stores data obtained by reading the original as image data (document) in the storage unit 1603.

The storage unit 1603 is a recording medium such as an HDD or a memory. The storage unit 1603 stores therein a local document stored in the MFP 800 in advance as well as image data (document) generated from the original read by the scanner unit 1602. Because the specific configuration of the storage unit 1603 is the same as that in the first embodiment, its explanation is omitted.

The printer unit 1604 includes an optical writing unit (not shown), a photosensitive element (not shown), an intermediate transfer belt (not shown), a charging unit (not shown), various rollers such as a fixing roller (not shown), and a catch tray (not shown). The printer unit 1604 prints out a document stored in the storage unit 1603 in accordance with a print instruction received from a user via the operation display unit 1601, and discharges a sheet with the printed document to the catch tray.

Although an operation performed by the MFP 800 is not explained with reference to the accompanying drawings, the scanner unit 1602 reads an original including a text, an image, an article, or the like in accordance with a user's instruction, and stores image data (document) obtained by reading the original in the storage unit 1603. Then, after the operations at steps S1301 to S1308 shown in FIG. 13 are performed, the printer unit 1604 performs an operation of printing out a document generated at steps S1301 to S1308. When the above operations end, all of the operations according to the third embodiment end.

As described above, the scanner unit 1602 reads data including a text or an image included in a document, the storage unit 1603 stores therein the data read by the scanner unit 1602, the input receiving unit 110 receives a keyword for extracting a content from a document. Furthermore, the content extracting unit 140 extracts a plurality of contents each including the keyword received by the input receiving unit 110 from a document, the relation calculating unit 150 calculates the degree of the semantic relatedness between the contents extracted by the content extracting unit 140, and the layout generating unit 160 determines positions of the contents on a new document based on the degree of the semantic relatedness between the contents and arranges the contents at the positions thereby generating the new document. Moreover, the printer unit 1604 prints out the new document generated by the layout generating unit 160. Thus, it is possible to generate and print out a new document by extracting contents from a document that is not stored in advance in a simple and objective manner without causing any inconvenience to users.

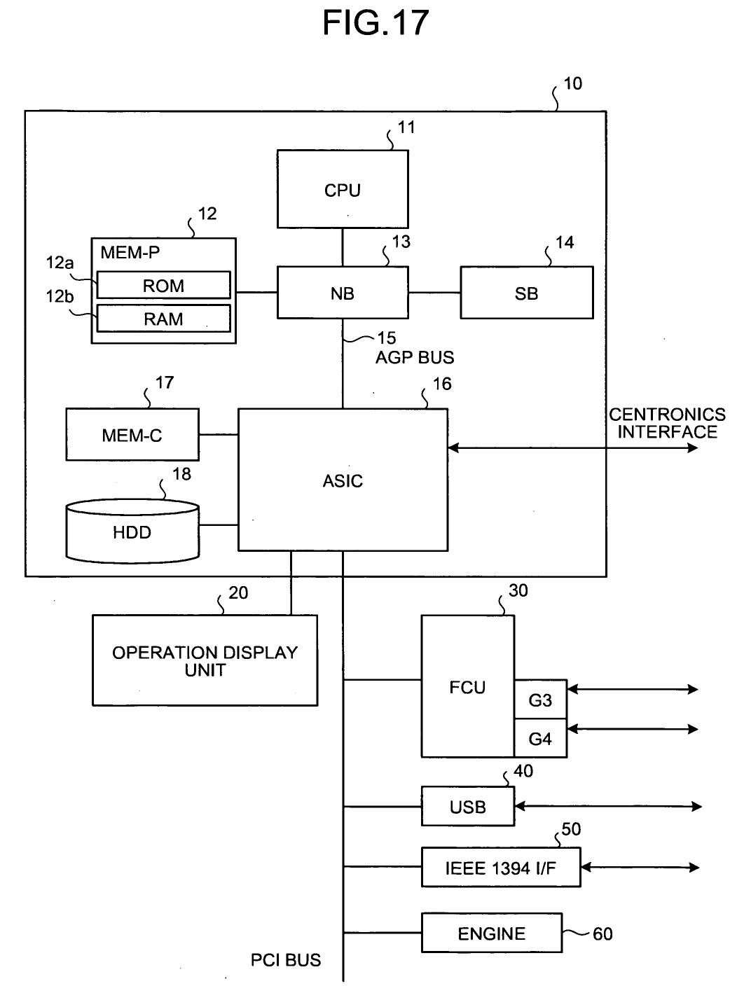

FIG. 17 is a block diagram for explaining the hardware configuration of the MFP 800. The MFP 800 includes a controller 10 and an engine 60 that are connected to each other via a peripheral component interconnect (PCI) bus. The controller 10 controls the entire MFP 800, a drawing operation, a communication, and an input received from an operation unit (not shown). The engine 60 is a printer engine or the like that can be connected to the PCI bus. The engine 60 is, for example, a monochrome plotter, a one-drum color plotter, a four-drum color plotter, a scanner, or a fax unit. The engine 60 includes an image processing unit that performs processing such as error diffusion and gamma conversion in addition to an engine unit such as a plotter.

The controller 10 includes a central processing unit (CPU) 11, a north bridge (NB) 13, a system memory (MEM-P) 12, a south bridge (SB) 14, a local memory (MEM-C) 17, an application specific integrated circuit (ASIC) 16, and an HDD 18. The NB 13 and the ASIC 16 are connected via an accelerated graphics port (AGP) bus 15. The MEM-P 12 includes a read-only memory (ROM) 12a and a RAM 12b.

The CPU 11 controls the MFP 800. The CPU 11 includes a chipset including the MEM-P 12, the NB 13, and the SB 14, and is connected to other devices via the chipset.

The NB 13 connects the CPU 11 to the MEM-P 12, the SB 14, and the AGP bus 15. The NB 13 includes a memory controller (not shown) that controls writing and reading to and from the MEM-P 12, a PCI master (not shown), and an AGP target (not shown).

The MEM-P 12 is a system memory used as, for example, a memory for storing therein computer programs and data, a memory for expanding computer programs and data, or a memory for drawing in a printer. The ROM 12a is used as a memory for storing therein computer programs and data. The RAM 12b is a writable and readable memory used as a memory for expanding computer programs and data and a memory for drawing in a printer.

The SB 14 connects the NB 13 to a PCI device (not shown) and a peripheral device (not shown). The SB 14 is connected to the NB 13 via the PCI bus. A network I/F unit (not shown) and the like are also connected to the PCI bus.

The ASIC 16 is an integrated circuit (IC) used for image processing and includes a hardware element used for image processing. The ASIC 16 serves as a bridge that connects the AGP bus 15, the PCI bus, the HDD 18, and the MEM-C 17 to one another. The ASIC 16 includes a PCI target (not shown), an AGP master (not shown), an arbiter (ARB) (not shown), a memory controller (not shown), a plurality of direct memory access controllers (DMACs) (not shown), and a PCI unit (not shown). The ARB is a central part of the ASIC 16. The memory controller controls the MEM-C 17. The DMACs rotate image data by hardware logic and the like. The PCI unit transmits data to the engine 60 via the PCI bus. The ASIC 16 is connected to a fax control unit (FCU) 30, a universal serial bus (USB) 40, and an Institute of Electrical and Electronics Engineers (IEEE) 1394 I/F 50 via the PCI bus. An operation display unit 20 is directly connected to the ASIC 16.

The MEM-C 17 is used as a copy image buffer and a code buffer. The HDD 18 is a storage that stores therein image data, computer programs, font data, and forms.

The AGP bus 15 is a bus I/F for a graphics accelerator card that has been proposed for achieving a high-speed graphic process. The AGP bus 15 directly accesses the MEM-P 12 with a high throughput, thereby achieving a high-speed process of the graphics accelerator card.

A computer program executed by each of the information processing apparatuses 100 and 500 and the MFP 800 is stored in a ROM or the like in advance. A computer program executed by the MFP 800 can be stored as an installable or executable file in a computer-readable recoding medium such as a compact disk read only memory (CD-ROM), a flexible disk (FD), a compact disk recordable(CD-R), or a digital versatile disk (DVD).

It is explained above that, in the information processing apparatuses 100 and 500 and the MFP 800, the operation of generating a new document by extracting a plurality of contents from a document stored in the storage unit is started when an instruction for generating a document is received from a user via the input receiving unit 110. However, for example, it is possible that various operations for extracting the contents and generating the new document are scheduled in the information processing apparatus or an image forming apparatus, and the user stores documents and a keyword or the like for extracting a content in a storage unit of the information processing apparatus or the image forming apparatus, so that a content is automatically extracted from a document stored in the storage unit at a predetermined timing (for example, at 10 a.m. on Mondays) to generate a new document. Thus, because the operations for extracting the contents and generating the new document are scheduled, it is possible to generate a new document by extracting the contents in a more efficient manner without causing any inconvenience to users.

Furthermore, it is explained above that, in the information processing apparatuses 100 and 500 and the MFP 800, information received by the input receiving unit 110 includes output setting information of a new document to be generated and a specified area of a document for identifying a content from the document. However, for example, when a new document is generated, the input receiving unit 110 can receive an input for specifying that a certain area (for example, the area from line 1 to line 5 on page 2) on the new document is unwritable or reserved, thereby preventing a content from being arranged at the area. Thus, because the input receiving unit 110 can receive such an input, it is possible for a user to generate a new document in a detailed manner.

A computer program executed by each of the information processing apparatuses 100 and 500 and the MFP 800 has a module configuration including the above units (the content extracting unit, the relation calculating unit, the layout generating unit, and the like). For actual hardware, a CPU reads the computer program from the ROM and executes the read computer program, so that the content extracting unit, the relation calculating unit, and the layout generating unit are loaded and created on a main storage device.

According to an aspect of the present invention, it is possible to generate a document by extracting contents in a simple and objective manner without causing any inconvenience to users.

Furthermore, it is possible to generate a document by extracting contents in a more objective and efficient manner.

Moreover, a user can visually determine the relatedness between the contents in a process of generating a document.

Furthermore, a user can promptly determine the relatedness between the contents in a process of generating the document.

Moreover, a user can determine the relatedness between the contents in a flexible manner in a process of generating the document.

Furthermore, a user can determine the relatedness between the contents more visually and intuitively.

Moreover, it is possible to generate a new document by accessing documents via the network and extracting contents from the document in a simple and objective manner without causing any inconvenience to users.

Furthermore, it is possible to generate and print out a new document by extracting contents from the document that is not stored in advance in a simple and objective manner without causing any inconvenience to users.

Moreover, it is possible to provide a computer program to be executed by a computer.

10-1. The method according to note 10, wherein

each of the contents includes any of image data and text data, and the image data includes attribute information indicating whether the image data includes a text, and

the extracting includes extracting the contents based on the content information received at the receiving and any of the attribute information included in the image data and a text included in the text data.

10-2. The method according to note 10-1, wherein

the attribute information is a text arranged around the image data, and

the extracting includes extracting the contents based on the content information received at the receiving and any of the attribute information arranged around the image data and the text included in the text data.

10-3. The method according to note 10, wherein the calculating includes generating a relation chart indicating similarity between the extracted contents by comparing the extracted contents, and calculating the degree of the semantic relatedness between the extracted contents based on the relation chart.
10-4. The method according to note 10, wherein the calculating includes generating a table indicating similarity between the extracted contents by comparing the extracted contents, and calculating the degree of the semantic relatedness between the extracted contents based on the table.
10-5. The method according to claim 10, wherein

the receiving includes receiving area information indicating a predetermined area in the document, and

the extracting includes extracting the contents from the predetermined area.

10-6. The method according to note 10, wherein

the calculating includes converting the degree of the semantic relatedness into a position relation in a coordinate system on the new document with one of the extracted contents as a reference, and

the determining includes determining positions of the extracted contents on the new document based on the position relation.

10-7. The method according to note 10, further comprising:

reading data including any of a text and an image included in the document with a reading unit and storing the data in the storage unit; and

printing out the new document with a printing unit.

10-8. The method according to note 10-7, wherein the method is realized on an image forming apparatus.
11-1. The computer-readable recording medium according to note 11, wherein

each of the contents includes any of image data and text data, and the image data includes attribute information indicating whether the image data includes a text, and

the extracting includes extracting the contents based on the content information received at the receiving and any of the attribute information included in the image data and a text included in the text data.

11-2. The computer-readable recording medium according to note 11-1, wherein

the attribute information is a text arranged around the image data, and

the extracting includes extracting the contents based on the content information received at the receiving and any of the attribute information arranged around the image data and the text included in the text data.

11-3. The computer-readable recording medium according to note 11, wherein the calculating includes generating a relation chart indicating similarity between the extracted contents by comparing the extracted contents, and calculating the degree of the semantic relatedness between the extracted contents based on the relation chart.
11-4. The computer-readable recording medium according to note 11, wherein the calculating includes generating a table indicating similarity between the extracted contents by comparing the extracted contents, and calculating the degree of the semantic relatedness between the extracted contents based on the table.
11-5. The computer-readable recording medium according to claim 11, wherein

the receiving includes receiving area information indicating a predetermined area in the document, and

the extracting includes extracting the contents from the predetermined area.

11-6. The computer-readable recording medium according to note 11, wherein

the calculating includes converting the degree of the semantic relatedness into a position relation in a coordinate system on the new document with one of the extracted contents as a reference, and

the determining includes determining positions of the extracted contents on the new document based on the position relation.

11-7. The computer-readable recording medium according to note 11, further comprising:

reading data including any of a text and an image included in the document with a reading unit and storing the data in the storage unit; and

printing out the new document with a printing unit.

11-8. The computer-readable recording medium according to note 11-7, wherein the method is realized on an image forming apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a storage unit that stores therein a document containing a plurality of contents;
an input receiving unit that receives content information;
a content extracting unit that extracts a plurality of contents each including the content information from among the contents contained in the document stored in the storage unit;
a relation calculating unit that calculates a degree of semantic relatedness between extracted contents extracted by the content extracting unit; and
a layout generating unit that determines positions of the extracted contents on a new document based on the degree of the semantic relatedness and arranges the extracted contents on the positions thereby generating the new document.

2. The information processing apparatus according to claim 1, wherein
each of the contents includes any of image data and text data, and the image data includes attribute information indicating whether the image data includes a text, and
the content extracting unit extracts the contents based on the content information received by the input receiving unit and any of the attribute information included in the image data and a text included in the text data.

3. The information processing apparatus according to claim 2, wherein
the attribute information is a text arranged around the image data, and
the content extracting unit extracts the contents based on the content information received by the input receiving unit and any of the attribute information arranged around the image data and the text included in the text data.

4. The information processing apparatus according to claim 1, wherein the relation calculating unit generates a relation chart indicating similarity between the extracted contents by comparing the extracted contents, and calculates the degree of the semantic relatedness between the extracted contents based on the relation chart.

5. The information processing apparatus according to claim 1, wherein the relation calculating unit generates a table indicating similarity between the extracted contents by comparing the extracted contents, and calculates the degree of the semantic relatedness between the extracted contents based on the table.

6. The information processing apparatus according to claim 1, wherein
the input receiving unit receives area information indicating a predetermined area in the document, and
the content extracting unit extracts the contents from the predetermined area.

7. The information processing apparatus according to claim 1, wherein
the relation calculating unit converts the degree of the semantic relatedness into a position relation in a coordinate system on the new document with one of the extracted contents as a reference, and
the layout generating unit determines positions of the extracted contents on the new document based on the position relation.

8. The information processing apparatus according to claim 1, further comprising:
a reading unit that reads data including any of a text and an image included in the document and stores the data read by the reading unit in the storage unit; and
a print unit that prints out the new document.

9. The information processing apparatus according to claim 8, wherein the information processing apparatus is an image forming apparatus.

10. A method of generating a document, the method comprising:
storing a document containing a plurality of contents in a storage unit;
receiving content information;
extracting a plurality of contents each including the content information from among the contents contained in the document stored in the storage unit;
calculating a degree of semantic relatedness between extracted contents extracted at the extracting;
determining positions of the extracted contents on a new document based on the degree of the semantic relatedness; and
arranging the extracted contents on the positions determined at the determining thereby generating the new document.

11. A computer-readable recording medium that stores therein a computer program containing computer program codes which when executed on a computer causes the computer to execute:
storing a document containing a plurality of contents in a storage unit;
receiving content information;
extracting a plurality of contents each including the content information from among the contents contained in the document stored in the storage unit;
calculating a degree of semantic relatedness between extracted contents extracted at the extracting;
determining positions of the extracted contents on a new document based on the degree of the semantic relatedness; and
arranging the extracted contents on the positions determined at the determining thereby generating the new document.
